(19) United States
(12) Patent Application Publication
(10) Pub. No.: US 2015/0085369 A1
(43) Pub. Date: Mar. 26, 2015

(54) LAMINATED BODY, IMAGING ELEMENT PACKAGE, IMAGING APPARATUS, AND ELECTRONIC APPARATUS

(71) Applicant: Sony Corporation, Tokyo (JP)

(72) Inventors: Hiroshi Tazawa, Kanagawa (JP); Kazuya Hayashibe, Kanagawa (JP)

(73) Assignee: Sony Corporation, Tokyo (JP)

(21) Appl. No.: 14/490,778

(22) Filed: Sep. 19, 2014

(30) Foreign Application Priority Data
Sep. 26, 2013 (JP) 2013-200327

(51) Int. Cl. G02B 1/11

(52) U.S. Cl. CPC G02B 1/118
USPC 359/601

(57) ABSTRACT

There is provided a laminated body, including a substrate and a structure layer which is provided on the substrate and has an anti-reflection function, in which the structure layer includes a plurality of structure bodies and an intermediate layer which is provided between the plurality of structure bodies and the substrate and, in which the intermediate layer satisfies a following relational expression (1). (2π/λ)·n(λ)·|d−d₀|<π (1) (where, λ represents a wavelength of light for a purpose of reduction of reflection, n(λ) represents a refractive index of the intermediate layer when the wavelength is λ, d₀ represents a thickness of the intermediate layer at a center point, and d represents a thickness of the intermediate layer at any point).

### CROSS REFERENCE TO RELATED APPLICATIONS

This application claims the benefit of Japanese Priority Patent Application JP 2013-200327 filed Sep. 26, 2013, the entire contents of which are incorporated herein by reference.

### BACKGROUND

The present technology relates to a laminated body having an anti-reflection function, an imaging element package, an imaging apparatus, and an electronic apparatus.

For a glass or a film used in a display, a camera lens, and the like, various anti-reflection technologies are used so as to suppress surface reflection. As the anti-reflection technology, a technology of forming a thin film with a lower refractive index than that of a substrate on a surface, and a technology of alternately laminating a high refractive index material and a low refractive index material are generally used.

However, the anti-reflection technology forms a thin film by using a vacuum process such as a sputtering, a vacuum deposition method, or the like, such that film-forming time increases and production efficiency is lowered. Furthermore, in the anti-reflection technology, since an interference phenomenon of light is used, reflectance depends on light wavelength or incident angle, and it is difficult to obtain a desired anti-reflection effect.

Recently, in order to solve these problems, a technology for achieving the anti-reflection performance by forming fine unevenness of which the size is equal to or less than a wavelength of light on the substrate surface has been developed, and is generally referred to as a moth-eye. The moth-eye has an advantage of obtaining the anti-reflection effect for a wider wavelength bandwidth compared to the above mentioned anti-reflection technology which uses an interference phenomenon of light and has less wavelength dependence.

Moth-eye is generally manufactured using a nano-imprint method (for example, refer to Japanese Unexamined Patent Application Publication No. 2010-156844). As the nano-imprint method, there are a thermal imprint method which plastically deforms the substrate by preparing a mold having a pattern opposite to a desired unevenness shape and heat-pressing the mold on the substrate, a thermal curable imprint method which applies a thermal curable resin (imprinting resin) to the substrate to press a mold on the substrate to be heat-cured, and a UV curable imprint method which applies a ultraviolet ray curable resin (imprinting resin) to a substrate, and irradiates the substrate with UV rays to be cured while pressing a mold on the substrate. When forming the moth-eye on an inorganic substrate such as a glass and the like, the thermal curable imprint method, and the UV curable imprint method are mainly used.

### SUMMARY

However, in the imprint method, interference fringes may occur on a surface which is imprint molded, thereby lowering visibility.

It is desirable to provide a laminated body, an imaging element package, an imaging apparatus and an electronic apparatus in which occurrence of the interference fringes is suppressed.

A laminated body according to an embodiment of the present technology includes a substrate and a structure layer which is provided on the substrate and has an anti-reflection function, in which the structure layer includes a plurality of structure bodies, and an intermediate layer which is provided between the plurality of structure bodies and the substrate, and in which the intermediate layer satisfies a following relational expression (1).

(2π/λ)·n(λ)−|d−d₀|<π (1)

(where, λ represents a wavelength of light for a purpose of reduction of reflection, n(λ) represents a refractive index of the intermediate layer when the wavelength is λ, d₀ represents a thickness of the intermediate layer at a center point, and d represents a thickness of the intermediate layer at any point)

An electronic apparatus according to another embodiment of the present technology includes a substrate and a structure layer which is provided on the substrate and has an anti-reflection function, in which the structure layer includes a plurality of structure bodies, and an intermediate layer which is provided between the plurality of structure bodies and the substrate, and in which the intermediate layer satisfies a following relational expression (2) in any section.

(2π/λ)·n(λ)·|D−D₀|<π (2)

(where, λ represents a wavelength of light for a purpose of reduction of reflection, n(λ) represents a refractive index of the intermediate layer when the wavelength is λ, D₀ represents a thickness of the intermediate layer at a center point of the section, and D represents a thickness of the intermediate layer at any point of the section)

An imaging element package according to still another embodiment of the present technology includes an imaging element, and a package which includes a light transmitting unit and accommodates the imaging element, in which the light transmitting unit includes a substrate, and a structure layer which is provided on the substrate and has an anti-reflection function, in which the structure layer includes a plurality of structure bodies, and an intermediate layer which is provided between the plurality of structure bodies and the substrate, and in which the intermediate layer satisfies a following relational expression (1).

(2π/λ)·n(λ)−|d−d₀|<π (1)

(where, λ represents a wavelength of light for a purpose of reduction of reflection, n(λ) represents a refractive index of the intermediate layer when the wavelength is λ, d₀ represents a thickness of the intermediate layer at a center point, and d represents a thickness of the intermediate layer at any point (a thickness of the intermediate layer at any point in a predetermined range centered on the center point))

The laminated body or the structure layer in the laminated body is suitably applied to an optical element, an optical system, an imaging apparatus, an imaging element package, an imaging module, an optical apparatus, an electronic apparatus, and the like. As the optical element, for example, a lens, a filter, a semi-transmissive mirror, a light control element, prism, a polarizing element, a display front plate, and the like are exemplified; however, the optical element is not limited thereto. As the imaging apparatus, for example, a digital camera, a digital video camera, and the like are exemplified; however, the imaging apparatus is not limited thereto. As the optical apparatus, for example, a telescope, a microscope, an exposure apparatus, a measuring apparatus, an inspection apparatus, an analyzing apparatus, and the like are exemplified; however, the optical apparatus is not limited thereto. As the electronic apparatus, a personal computer, a mobile phone, a tablet computer, a display apparatus, and the like are exemplified; however, the electronic apparatus is not limited thereto.

As described above, it is possible to suppress occurrence of interference fringes in a transparent laminated body according to the present technology.

### BRIEF DESCRIPTION OF THE DRAWINGS

FIG. 1A is a plan view which illustrates an example of a configuration of a transparent laminated body according to a first embodiment of the present technology;

FIG. 1B is an enlarged plan view which illustrates a portion of a surface of the transparent laminated body shown in FIG. 1A;

FIG. 1C is a cross-sectional view taken along line IC-IC of FIG. 1B;

FIG. 2A is a cross-sectional view which illustrates an example of an intermediate layer which changes in thickness in a surface direction of a substrate;

FIG. 2B illustrates a change in reflectance with respect to a thickness of the intermediate layer;

FIGS. 3A to 3D are process drawings for describing an example of a method of manufacturing a transparent laminated body according to the first embodiment of the present technology;

FIGS. 4A to 4C are process drawings for describing an example of the method of manufacturing a transparent laminated body according to the first embodiment of the present technology;

FIG. 5A is a cross-sectional view which illustrates an example of a configuration of a transparent laminated body according to Modification Example 1 of the first embodiment of the present technology;

FIG. 5B is a cross-sectional view which illustrates an example of the configuration of a transparent laminated body according to Modification Example 2 of the first embodiment of the present technology;

FIG. 6 is a cross-sectional view which illustrates an example of the configuration of a transparent laminated body according to Modification Example 3 of the first embodiment of the present technology;

FIG. 7A is a cross-sectional view which illustrates an example of an appearance of a transparent laminated body according to Modification Example 4 of the first embodiment of the present technology;

FIG. 7B is a cross-sectional view which illustrates an example of a configuration of the transparent laminated body according to Modification Example 4 of the first embodiment of the present technology;

FIG. 8A is a cross-sectional view which illustrates an example of a configuration of an imaging element package according to a second embodiment of the present technology;

FIG. 8B is a cross-sectional view which illustrates an example of a configuration of an imaging element package according to a modification example of the second embodiment of the present technology;

FIG. 9 is a cross-sectional view which illustrates an example of a configuration of a camera module according to a third embodiment of the present technology;

FIG. 10 is a schematic view which illustrates an example of a configuration of an imaging apparatus according to a fourth embodiment of the present technology;

FIG. 11 is a schematic view which illustrates an example of a configuration of an imaging apparatus according to a fifth embodiment of the present technology;

FIG. 12 is a perspective view which illustrates an example of an appearance of a first electronic apparatus according to a sixth embodiment of the present technology;

FIG. 13A is a perspective view which illustrates an example of an appearance at a front surface side of a second electronic apparatus according to the sixth embodiment of the present technology;

FIG. 13B is a perspective view which illustrates an example of an appearance at a back surface side of the second electronic apparatus according to the sixth embodiment of the present technology;

FIG. 14A is a perspective view which illustrates an example of an appearance at a front surface side of a third electronic apparatus according to a seventh embodiment of the present technology;

FIG. 14B is a perspective view which illustrates an example of an appearance at a back surface side of the third electronic apparatus according to the seventh embodiment of the present technology;

FIG. 15A illustrates a reflection spectrum of a transparent laminated body according to Reference example 1; and

FIG. 15B illustrates a reflection spectrum of a transparent laminated body according to Reference Example 2.

### DETAILED DESCRIPTION OF EMBODIMENTS

The present inventors have performed a keen examination so as to elucidate a reason for the occurrence of the above-mentioned interference fringes. As a result, the inventors have elucidated a reason for the occurrence of the interference fringes. That is, in a method of applying a resin to a substrate such as a glass, a film, or the like and performing imprinting, an intermediate layer made of an imprinting resin is formed between a plurality of structure bodies and the substrate. Moreover, in the above-mentioned imprint method, materials of the substrate and the imprinting resin are generally different from each other, thereby causing a difference between refractive indexes of both materials. Thus, Fresnel reflection occurs at an interface between the substrate and the intermediate layer. When such a Fresnel reflection occurs and a thickness of the intermediate layer varies, the interference fringes may occur on a molded surface.

Therefore, the present inventors have repeatedly performed a keen examination on a technology of suppressing occurrence of the interference fringes. As a result, the inventors have found out a method of making the intermediate layer which satisfies a following relational expression (1).

(2π/λ)·n(λ)−|d−d₀|<π (1)

(where, λ represents a wavelength of light for a purpose of reduction of reflection, n(λ) represents a refractive index of the intermediate layer when the wavelength is λ, d₀ represents a thickness of the intermediate layer at a center point, and d represents a thickness of the intermediate layer at any point)

Embodiments of the present technology will be described in a following order.

1. First embodiment (an example of a transparent laminated body including a plurality of convex structure bodies)
1.1 A configuration of a transparent laminated body
1.2 A method of manufacturing a transparent laminated body
1.3 Effects
1.4 Modification Examples

2. Second embodiment (an example in which the transparent laminated body is applied to an imaging element package)

3. Third embodiment (an example in which the transparent laminated body or a structure layer is applied to a camera module)

4. Fourth embodiment (an example in which the transparent laminated body or the structure layer is applied to a digital camera)

5. Fifth embodiment (an example in which the transparent laminated body or the structure layer is applied to a digital video camera)

6. Sixth embodiment (an example in which the transparent laminated body or the structure layer is applied to an electronic apparatus)

### 1. First Embodiment

### 1.1 Configuration of a Transparent Laminated Body

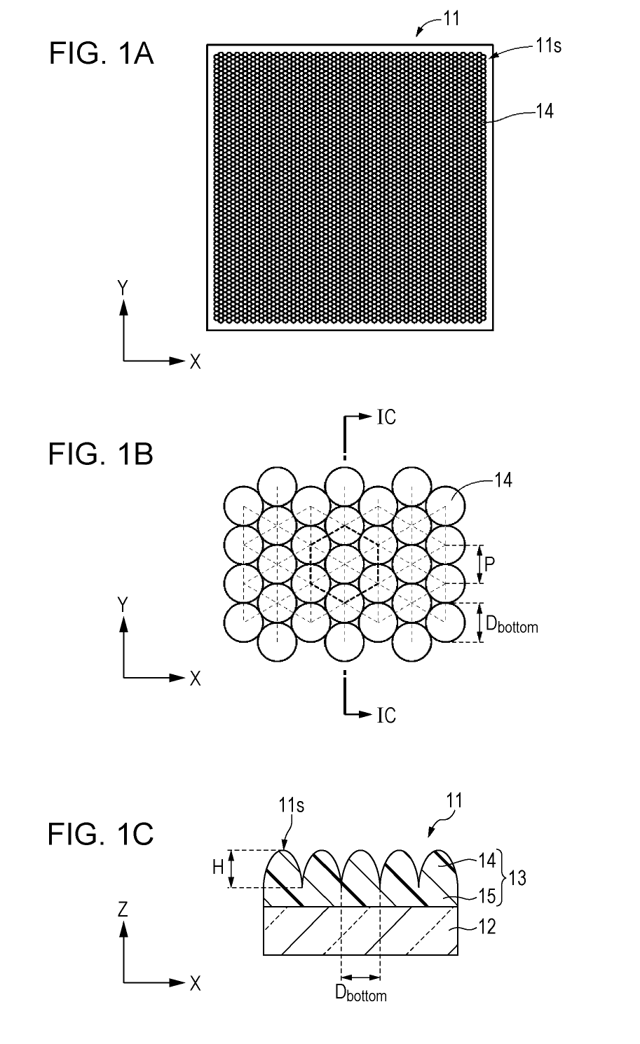

Hereinafter, an example of a configuration of a transparent laminated body 11 will be described referring to FIGS. 1A to 1C. The transparent laminated body 11 includes a surface 11s having an anti-reflection function. On the surface 11s, a fine unevenness is provided. The transparent laminated body 11 includes a substrate 12 having a surface, and a structure layer 13 provided on a surface of the substrate 12. The substrate 12 and the structure layer 13 are configured of different materials, and to have different refractive indexes. Thus, Fresnel reflection occurs at an interface between the substrate 12 and the structure layer 13. Here, two directions which are orthogonal to each other in a surface of the substrate 12 are referred to as an X axis direction (first direction) and a Y axis direction (second direction), respectively, and a direction perpendicular to the surface (XY plane) is referred to as a Z direction (third direction).

A size of the transparent laminated body 11 is substantially the same size as a surface (applied surface) of an application object. As the application object, for example, window materials such as an image sensor cover glass and the like, filters such as a camera ND filter and the like, lenses such as a camera lens and the like, optical elements such as a semi-transmissive mirror, a light control element, a prism, a polarizing element, a display front plate, and the like are exemplified; however, the application object is not limited thereto.

Hereinafter, the substrate 12 and the structure layer 13 which are included in the transparent laminated body 11 will be sequentially described.

### Substrate

The substrate 12 has transparency. A material of the substrate 12 may be a material having transparency, and may be any one of an organic material and an inorganic material. As a material of an inorganic substrate, for example, quartz, sapphire, glass, and the like are exemplified. As an organic material, it is possible to use, for example, a common high polymer material. As a common high polymer material, specifically, for example, triacetylcellullose (TAC), polyester (TPEE), polyethylene terephthalate (PET), polyethylene naphthalate (PEN), polyimide (PI), polyamide (PA), aramid, polyethylene (PE), polyacrylate, polyether sulfone, polysulfone, polypropylene (PP), diacetyl cellulose, polyvinyl chloride, acrylic resin (PMMA), polycarbonate (PC), epoxy resin, urea resin, urethane resin, melamine resin, cyclo-olefin polymer (COP), cyclo-olefin copolymer, and the like are exemplified.

When using the organic material as a material of the substrate 12, an undercoat layer may be provided as surface processing so as to improve a surface energy, coating properties, slip properties, flatness, and the like of a surface of the substrate 12. As a material of the undercoat layer, for example, organoalkoxymetal compound, polyester, acrylic-modified polyester, polyurethane, and the like are exemplified. In addition, in order to obtain the same effect as providing the undercoat layer, surface processing such as corona discharge, UV irradiation processing, and the like may be performed on the surface of the substrate 12.

As a shape of the substrate 12, for example, a film shape, a plate shape, and a block shape can be exemplified; however, the shape of the substrate 12 is not limited to these shapes. Here, the film shape is defined to include a sheet shape. A thickness of the substrate 12 is, for example, about 25 μm to 500 μm. When the substrate 12 is a plastic film, the substrate 12 can be obtained by a method of, stretching the above-mentioned resin, a method of, after diluting the resin with a solvent, depositing the resin in a film shape, and drying the resin and the like. The substrate 12 may be a configuration element of a member, an apparatus, and the like which is an application object of the transparent laminated body 11.

The surface of the substrate 12 is not limited to have a flat surface, but may have an unevenness surface, a polygonal surface, a curved surface, or a combination of these shapes. As a curved surface, for example, a partial spherical surface, a partial ellipsoid surface, a partial paraboloid surface, a free curved surface, and the like are exemplified. Here, the partial spherical surface, the partial ellipsoid surface, and the partial paraboloid surface mean a portion of a spherical surface, an ellipsoid surface, and a paraboloid surface, respectively.

FIG. 1A illustrates an example in which a shape of the surface of the substrate 12 viewed from a Z axis direction is a rectangular shape; however, the surface shape of the substrate 12 is not limited to a rectangular shape, but can be selected according to a surface shape of a member, an apparatus, or the like to which the transparent laminated body 11 is applied.

### Structure Layer

The structure layer 13 is an anti-reflection layer having an anti-reflection function. The structure layer 13 includes a plurality of structure bodies 14, and an intermediate layer (optical layer) 15 provided between a lower portion of the plurality of structure bodies 14 and the surface of the substrate 12.

### Structure Body

The structure body 14 is a so-called sub-wavelength structure body. The structure body 14 has a convex shape with respect to a surface of the substrate 12. The plurality of structure bodies 14 are disposed at a pitch P of a wavelength bandwidth or less of light for a purpose of reduction of reflection. Here, the wavelength bandwidth of light for a purpose of reduction in reflection is, for example, a wavelength bandwidth of ultraviolet light, a wavelength bandwidth of visible light, or a wavelength bandwidth of infrared light. The wavelength bandwidth of ultraviolet light refers to a wavelength bandwidth of 10 nm or more and less than 350 nm, the wavelength bandwidth of visible light refers to a wavelength bandwidth of 350 nm to 850 nm, and the wavelength bandwidth of infrared light refers to a wavelength bandwidth of more than 850 nm to 1 mm.

For example, the plurality of structure bodies 14 are arranged so as to form a plurality of rows on a surface of the substrate 12. The rows may be either in a straight line shape or in a curve shape. A plurality of rows in some regions on a surface of the substrate 12 may be in a straight line shape, and a plurality of rows in the other regions may be in a curve shape. As a curve, a curve periodically or non-periodically meandering is exemplified. As such a curve, waveforms such as sine wave, triangular wave, and the like can be exemplified; however, the curve is not limited thereto.

A disposition of a plurality of structure bodies 14 on a surface of the substrate 12 may be any one of a regular disposition and an irregular disposition. As the regular disposition, a lattice-shaped disposition such as a tetragonal lattice, a quasi-tetragonal lattice, a hexagonal lattice, a quasi-hexagonal lattice, and the like are preferred. FIG. 1B illustrates an example in which the plurality of structure bodies 14 are disposed in a hexagonal lattice shape. Here, a square lattice refers to a lattice of a regular square shape. Unlike the lattice of a regular square shape, a quasi-square lattice refers to a lattice of a distorted regular square shape. The hexagonal lattice refers to a lattice of a regular hexagonal shape. Unlike the lattice of a regular hexagonal shape, a quasi-hexagonal lattice refers to a lattice of a distorted regular hexagonal shape.

As a specific shape of the structure body 14, for example, a cone shape, a pillar shape, a needle shape, a semi-sphere shape, a semi-ellipse shape, a polygonal shape, and the like are exemplified. However, the specific shape of the structure body is not limited to these shapes, but other shapes may be adopted. As the cone shape, for example, a cone shape whose top is pointed, a cone shape whose top is flat, and a cone shape with a convex-shaped curved surface or a concave-shaped curved surface at a top thereof are exemplified; however, the cone shape is not limited these shapes. As a cone shape with a convex-shaped curved surface at a top, a secondary curved surface shape such as a parabolic surface shape, and the like are exemplified. In addition, a conical surface of the cone shape may be curved in a concave shape or a convex shape.

The plurality of structure bodies 14 provided on the surface of the substrate 12 may all have the same size, shape, and height, and the plurality of structure bodies 14 may include those having different sizes, shapes, or heights. Furthermore, the plurality of structure bodies 14 may include structure bodies connecting lower portions with each other to be overlapped.

### Intermediate Layer

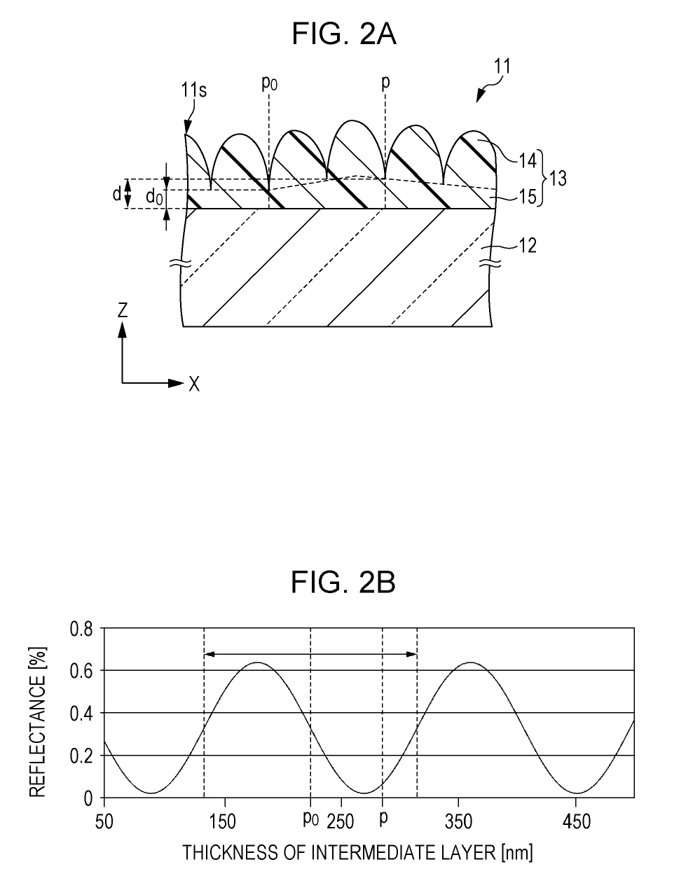

An intermediate layer 15 is a layer which is integrally molded with a structure body 14 at a lower portion side of the structure body 14, and configured of the same material as the structure body 14. A thickness d of the intermediate layer 15, as shown in FIG. 2A, may change in a surface direction of the surface of the substrate 12. By allowing such a change, it is unnecessary to make a thickness of the intermediate layer 15 completely uniform in a transfer process, such that molding of the structure layer 13 becomes easy. A reflectance of a surface 11s of the transparent laminated body 11, as shown in FIG. 2B, periodically varies with an increase in a thickness d of the intermediate layer 15. Specifically, a change in the reflectance of the surface 11s of the transparent laminated body 11 with respect to a thickness d of the intermediate layer 15 is represented by a sine wave. Here, a distance from the surface of the substrate 12 to a deepest position of a valley portion between adjacent structure bodies 14 is defined as a thickness of the intermediate layer 15.

The intermediate layer 15 satisfies a following relational expression (1), and thereby it is possible to prevent interference fringes from occurring on the surface 11s of the transparent laminated body 11. That is, it is possible to prevent light and shade from being repeatedly changed in the surface direction of the surface of the substrate 12.

(2π/λ)·n(λ)−|d−d₀|<π (1)

(where, λ represents a wavelength of light for a purpose of reduction of reflection, n(λ) represents a refractive index of the intermediate layer 15 when the wavelength is λ, d₀ represents a thickness of the intermediate layer 15 at a center point p₀, and d represents a thickness of the intermediate layer 15 at any point p)

It is preferable that the intermediate layer 15 satisfy a following relational expression (2). This is because it is possible to further suppress occurrence of light and shade in the surface of the substrate 12.

(2π/λ)·n(λ)·|d−d₀|<π/2 (2)

A thickness of the intermediate layer 15 is in a scope of preferably 10 nm to 50 μm, more preferably 30 nm to 25 μm, far more preferably 50 nm to 10 μm. If the thickness exceeds 50 μm, when forming the intermediate layer 15 by curing a resin, there is a possibility that poor adhesion occurs at an interface between the intermediate layer 15 and the substrate 12 by a curing shrinkage of the resin. Moreover, there is also a concern of a decrease in transmittance. On the other hand, if the thickness is less than 10 nm, when stress is applied to the structure body 14, the stress may not escape to the intermediate layer 15 below the structure body 14, and there is a concern of a decrease in mechanical properties of the transparent laminated body 11 due to as a broken structure body 14 and the like.

### Optical Properties

It is preferable that a maximum reflectance of the structure layer 13 itself with respect to light for a purpose of reduction in reflection be 0.21% or less. Accordingly, it is possible to suppress ripple in a spectral reflection spectrum, and to realize the transparent laminated body 11 which has an excellent anti-reflection effect. It is preferable that a maximum reflectance of the transparent laminated body 11 with respect to the light for a purpose of reduction in reflection be 1.00% or less. Here, a maximum reflectance of any one of the structure layer 13 itself and the transparent laminated body 11 also means a maximum reflectance at the surface 11s side having an anti-reflection function.

A refractive index difference Δn(=|n₁−n₀|) between a refractive index n₀ of the substrate 12 and a refractive index n₁ of the structure layer 13 is in a scope of preferably 0.3 or less, more preferably 0.2 or less, far more preferably 0.1 or less. When the refractive index difference Δn is 0.3 or less, a good anti-reflection property is obtained.

### 1.2 A Method of Manufacturing a Transparent Laminated Body

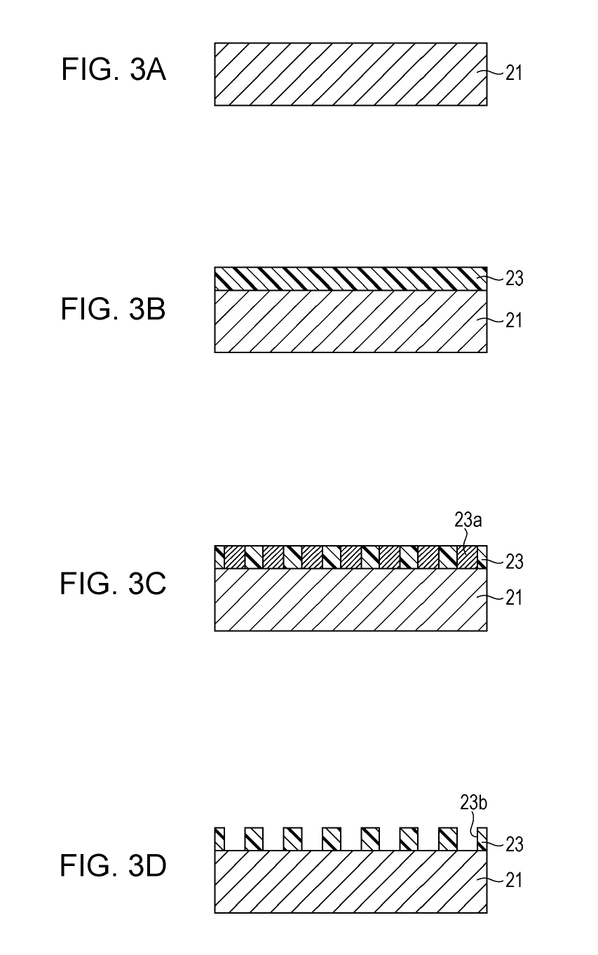

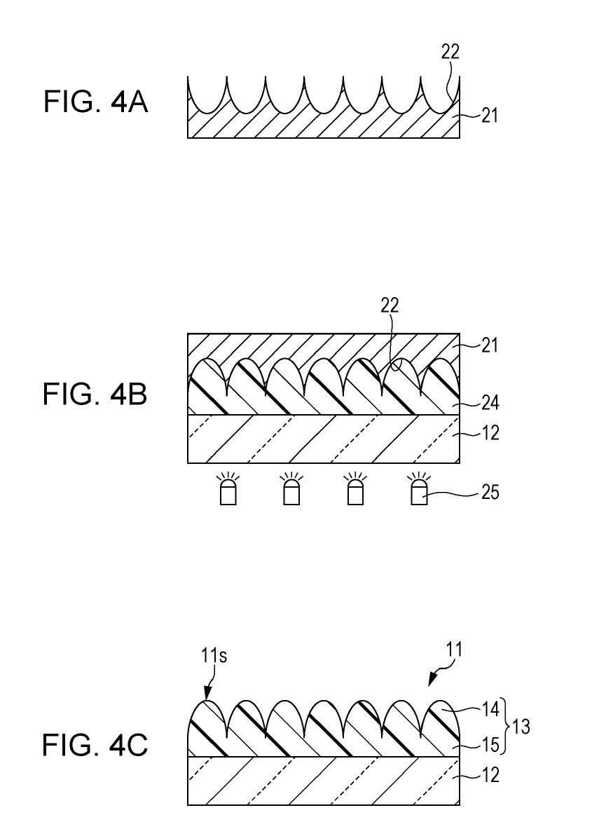

Next, an example of a method of manufacturing the transparent laminated body 11 according to a first embodiment of the present technology will be described referring to FIGS. 3A to 4C. In the following, a case of manufacturing a master disk by photolithography is described as an example. However, the method of manufacturing a master (mold) is not limited thereto, but may be anodic oxidation, a method in which a master manufacturing process of an optical disk and an etching process are fused (for example, refer to Japanese Unexamined Patent Application Publication No. 2010-156844) and the like. Moreover, a duplicate master may be manufactured from the master disk by performing electroforming.

### Resist Deposition Process

First, as shown in FIG. 3A, a master 21 of a disk shape and the like are prepared. Next, as shown in FIG. 3B, a resist layer 23 is formed on a surface of the master 21. As a material of the resist layer 23, for example, any one of organic resist and inorganic resist may be used. As the organic resist, it is possible to use, for example, a novolac-based resist or a chemically amplified resist. In addition, as the inorganic resist, it is possible to use, for example, a metal compound of one type or more.

### Exposure Process

Next, as shown in FIG. 3C, a plurality of exposure portions (exposure patterns) 23a are formed on the resist layer 23 formed on the surface of the master 21. The plurality of exposure portions 23a are formed at intervals of a wavelength bandwidth or less of the light for a purpose of reduction in reflection in the transparent laminated body 11. The exposure pattern configured to have the plurality of exposure portion 23a may be any one of a regular pattern and an irregular pattern. As the regular pattern, patterns of a lattice shape such as a square lattice, a quasi-square lattice, a hexagonal lattice, a quasi-hexagonal lattice, and the like are preferred.

### Developing Process

Next, the resist layer 23 is developed by, for example, dropping a developing solution on the resist layer 23 while rotating the master 21. Thus, as shown in FIG. 3D, a plurality of openings 23b are formed on the resist layer 23. When forming the resist layer 23 by a positive resist, the exposure portion has an increased dissolution rate in a developing solution compared to a non-exposure portion, such that, as shown in FIG. 3D, a pattern of an opening 23b corresponding to the exposure portion (latent image) 23a is formed on the resist layer 23.

### Etching Process

Next, with a pattern (resist pattern) of the resist layer 23 formed on the master 21 as a mask, a surface of the master 21 is etched. Accordingly, as shown in FIG. 4A, a plurality of concave-shaped structure bodies 22 are formed on the surface of the master 21. The etching may be any one of dry etching and wet etching. In the present process, an etching process and an ashing process may be alternately performed. Accordingly, it is possible to make a shape of each structure body 22 in a cone shape.

Thus, the master 21 which is targeted is obtained.

As the master 21, it is possible to use a mold (hard mold) configured of, for example, a glass, silicon, nickel, or the like. By thermal imprint, UV imprint, or the like, using such a hard mold, a replica is made by transferring a shape to a type of a resin material, a film, or the like, and the replica may be used as a mold (soft mold).

Flatness, thickness accuracy, and the like of these molds are preferably adjusted so that the intermediate layer 15 satisfying the above-mentioned relational expression (1) may be formed.

### Transfer Process

Next, shape transfer to a resin material is performed by a nano-imprint method. As a press device used in imprint, for example, a press device which includes a metal plate as a lower plate and includes a metal plate (in the case of thermal curing imprint method), or a quartz glass plate (in the case of UV curing imprint method) as an upper plate is used. In the press device having such a configuration, in-plane accuracy, parallelism, and in-plane pressure distribution of a plate is preferably adjusted so that the intermediate layer 15 satisfies the above-mentioned relational expression (1).

Specifically, as shown in FIG. 4B, after bringing the master 21 and a transfer material 24 applied onto the substrate 12 in close contact with each other, the transfer material 24 is cured by irradiating the transfer material 24 with energy rays such as ultraviolet rays from an energy ray source 25 and the substrate 12 which is integrated with the cured transfer material 24 is peeled off.

Alternatively, after bringing the master 21 and the transfer material 24 applied onto the substrate 12 in close contact with each other, the transfer material 24 is cured by heating the transfer material 24 using a heat source such as a heater and the like, and the substrate 12 which is integrated with the cured transfer material 24 is peeled off. Accordingly, as shown in FIG. 4C, the structure layer 13 is formed on a surface of the substrate 12. Next, the transparent laminated body 11 may be cut to a desired size when necessary.

The energy ray source 25 may be a source which is capable of emitting energy rays such as electronic rays, ultraviolet rays, infrared rays, laser rays, visible rays, ionizing radiation (X-rays, α-rays, β-rays, γ-rays, and the like), a microwave, high-frequency rays or the like; however, the energy ray source is not particularly limited thereto.

As the transfer material 24, it is preferable to use an energy ray curable resin composition or a thermosetting resin, and these may be combined to be used. As an energy ray curable resin composition, it is preferable to use a ultraviolet ray curable resin composition, and for example, it is possible to use an acrylic resin material, an epoxy-based resin material, and the like. As the thermosetting resin, it is possible to use inorganic materials such as glass and the like. The transfer material 24 may include a filler, a functional additives, or the like when necessary.

A ultraviolet ray curable resin composition includes, for example, acrylate and an initiator. The ultraviolet ray curable resin composition includes a mono-functional monomer, a bi-functional monomer, a poly-functional monomer, and the like. Specifically, the ultraviolet ray curable resin composition is made by a single material alone or a mixture of two or more materials shown below.

As the mono-functional monomer, for example, carboxylic acids (acrylic acid), hydroxy acids (2-hydroxyethyl acrylate, 2-hydroxypropyl acrylate, 4-hydroxy butyl acrylate), alkyl, alicyclic acids (isobutyl acrylate, t-butyl acrylate, isooctyl acrylate, lauryl acrylate, stearyl acrylate, isobornyl acrylate, cyclohexyl acrylate), other functional monomers (2-methoxyethyl acrylate, methoxyethylene glycol acrylate, 2-ethoxyethyl acrylate, tetrahydrofurfuryl acrylate, benzyl acrylate, ethylcarbitol acrylate, phenoxy ethyl acrylate, N,N-dimethylaminoethyl acrylate, N,N-dimethylaminopropyl acrylamide, N,N-dimethylacrylamide, acryloylmorpholine, N-isopropyl acrylamide, N,N-diethyl acrylamide, N-vinyl pyrrolidone, 2-(perfluorooctyl)ethyl acrylate, 3-perfluoro-hexyl-2-hydroxypropyl acrylate, 3-perfluorooctyl-2-hydroxypropyl acrylate, 2-(perfluorodecyl)ethyl acrylate, 2-(perfluoro-3-methylbutyl)ethyl acrylate), 2,4,6-tribromophenol acrylate, 2,4,6-tribromophenol methacrylate, 2-(2,4,6-tribromo-phenoxy)ethyl acrylate), 2-ethylhexyl acrylate, and the like can be exemplified.

As the bi-functional monomer, for example, tri(propylene glycol)diacrylate, trimethylolpropane diallyl ether, urethane acrylate, and the like can be exemplified.

As the poly-functional monomer, for example, trimethylol propane triacrylate, dipentaerythritol penta and hexacrylate, ditrimethylolpropane tetraacrylate, and the like can be exemplified.

As the initiator, for example, 2,2-dimethoxy-1,2-diphenyl-ethane-1-on, 1-hydroxycyclohexyl-phenylketone, 2-hydroxy-2-methyl-1-phenylpropane-1-on, and the like can be exemplified.

As the filler, for example, it is possible to use any one of inorganic fine particles and organic fine particles. As the inorganic fine particles, for example, metal oxide fine particles such as SiO₂, TiO₂, ZrO₂, SnO₂, Al₂O₃, and the like can be exemplified.

As the functional additives, for example, a leveling agent, a surface conditioning agent, anti-form, and the like can be exemplified. A method of molding the substrate 12 is not particularly limited, and the substrate 12 may be injection molded body, an extrusion-molded body, and a cast molded body. Surface processing such as corona processing and the like may be performed on the substrate surface when necessary.

As described above, the transparent laminated body 11 of interest may be obtained.

### 1.3 Effects

In the transparent laminated body 11 according to a first embodiment, the intermediate layer 15 satisfies the above-mentioned relational expression (1), such that it is possible to suppress occurrence of interference fringes. Thus, when applying the transparent laminated body 11 to a display device or a camera, it is possible to realize a display with excellent visibility, or a camera without unexpected reflection caused by stray light.

When a maximum reflectance of the structure layer 13 itself with respect to the light for a purpose of reduction in reflection is 0.2% or less, ripples in a spectral reflection spectrum are suppressed. Therefore, the occurrence of interference fringes is suppressed, and it is possible to realize the transparent laminated body 11 with an excellent anti-reflection effect.

### 1.4 Modification Example

### Modification Example 1

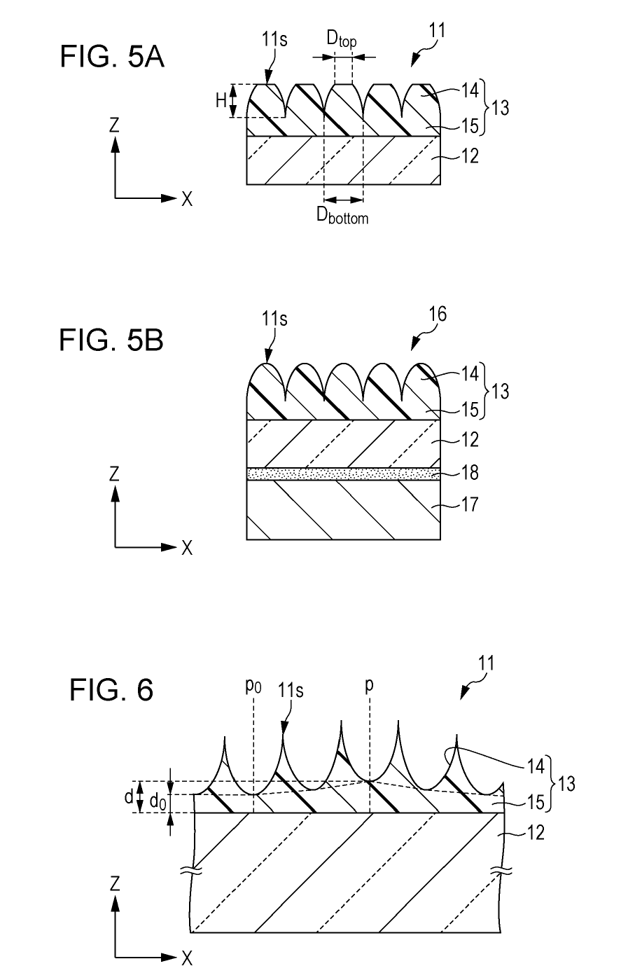

As shown in FIG. 5A, the structure body 14 may have a substantially planar top. A plane of the top is substantially parallel to, for example, the surface of the substrate 12. It is preferable that a diameter D_{bottom} at a bottom of the structure body 14 and a pitch P of the structure body 14 satisfy a relationship of 1.2>D_{bottom}/P>1, and that a diameter Dₜₒₚ of a top of the structure body 14 and the diameter D_{bottom} of the bottom of the structure body 14 satisfy a relationship of 0<Dₜₒₚ/D_{bottom}≦1/10, and thereby it is possible to obtain excellent anti-reflection properties. For example, a maximum reflectance of the structure layer 13 itself with respect to the light for a purpose of reduction in reflection can be set to 0.2% or less. Here, 1.2>D_{bottom}/P>1 means that lower portions of the adjacent structure bodies 14 overlap with each other. However, when 1.2>D_{bottom}/P is satisfied and an overlap becomes large, a height of the structure body on appearance tends to be lowered and anti-reflection properties tend to be degraded.

When the structure body 14 has a pointed top or a planar top, it is preferable that a diameter D_{bottom} of a bottom of the structure body 14 and a pitch P of the structure body 14 satisfy a relationship of 1.2>D_{bottom}/P>1, and a diameter Dₜₒₚ of a top of the structure body 14 and the diameter D_{bottom} of the bottom of the structure body 14 satisfy a relationship of 0≦Dₜₒₚ/D_{bottom}≦1/10. As a pointed top shape, for example, a convex curved surface, a needle shape, and the like are exemplified; however, the pointed top shape is not limited thereto.

### Modification Example 2

As shown in FIG. 5B, an optical element 16 with an anti-reflection function may be configured by providing the transparent laminated body 11 on a surface of the optical element 17. In this case, the transparent laminated body 11 and the optical element 17 are bonded to each other by an adhesion layer 18. As an adhesive which configures the adhesion layer 18, it is possible to use one type or more selected from a group made of, for example, an acrylic adhesive, a silicone-based adhesive, a urethane adhesive, and the like. In the present technology, pressure sensitive adhesion is defined as a type of adhesion. According to this definition, a pressure sensitive adhesion layer is regarded as a type of adhesion layer.

### Modification Example 3

In the first embodiment, a case where the structure body 14 has a convex shape with respect to the surface of the substrate 12 is described as an example (refer to FIGS. 2A and 2B), but the structure body 14 may have a concave shape with respect to the surface of the substrate 12 as shown in FIG. 6. In this case, a distance from the surface of the substrate 12 to a position in which the concave shaped structure body 14 has a deepest depth is defined as a thickness of the intermediate layer 15.

### Modification Example 4

In the first embodiment, a case where a size of the transparent laminated body 11 is substantially the same as a size of a surface (applied surface) of the application object is described as an example; however, the transparent laminated body 11 may be larger than the surface of the application object. For example, the transparent laminated body 11 may be a raw film. In this case, the transparent laminated body 11 is cut into a surface size of an application object such as an image sensor cover glass, an ND filter, or the like to be used.

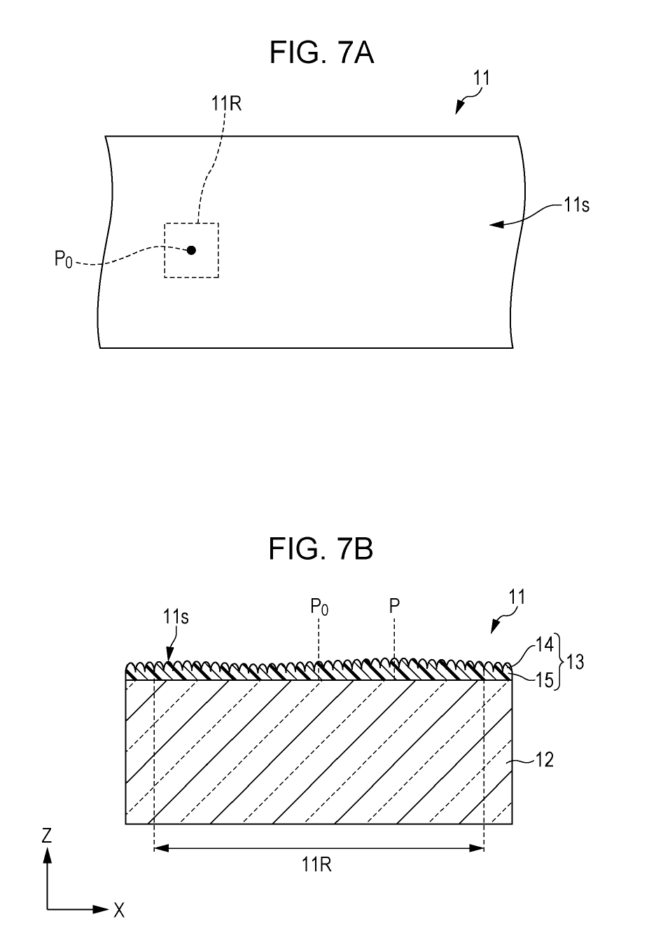

In FIG. 7A, an example that any section 11R having a size substantially the same as the surface of the application object is cut from the transparent laminated body 11 of a stripe shape to be used is shown. A thickness of the intermediate layer 15 of the transparent laminated body 11 may change in a surface direction of the surface of the substrate 12 as shown in FIG. 7B.

As described above, when cutting a portion of the section 11R to be used, the intermediate layer 15 satisfies a following relational expression (2). By satisfying the relational expression (2), when applying a cut section 11R to the surface of the application object, it is possible to prevent interference fringes from occurring on an applied surface of the application object.

(2π/λ)·n(λ)·|D−D₀|<π (2)

(where, λ represents a wavelength of light for a purpose of reduction of reflection, n(λ) represents a refractive index of the intermediate layer 15 when the wavelength is λ, D₀ represents a thickness of the intermediate layer 15 at a center point P₀ of the section 11R, and D represents a thickness of the intermediate layer 15 at any point P of the section 11R)

### 2. Second Embodiment

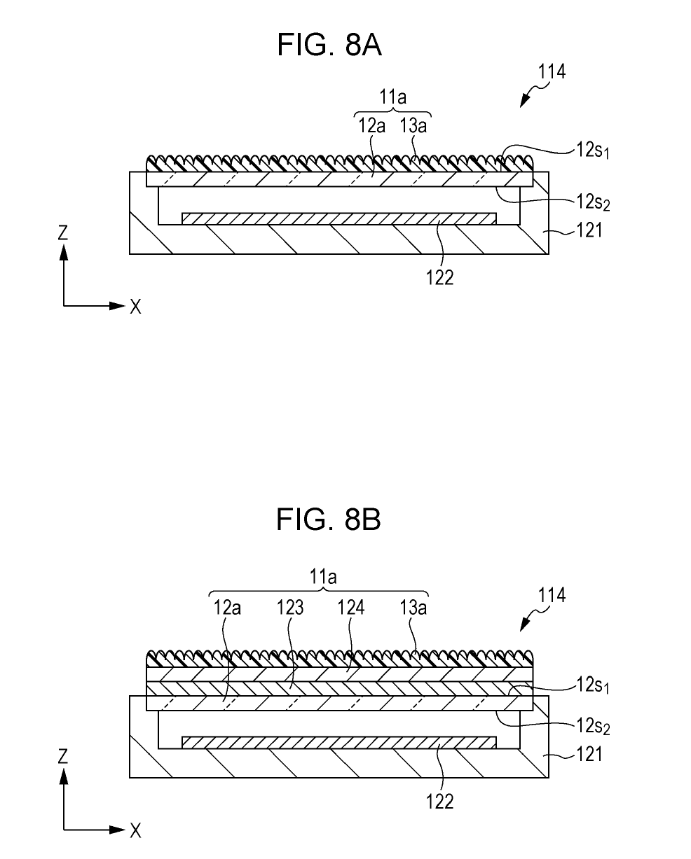

As shown in FIG. 8A, an imaging element package (hereinafter, referred to as “element package”) 114 according to a second embodiment of the present technology includes a package 121, an imaging element 122 accommodated in the package 121, a transparent laminated body (light transmitting unit) 11a which is fixed to cover an opening window of the package 121.

A transparent laminated body 11a includes a cover glass (cover body) 12a which is a substrate, and a structure layer 13a provided on a surface of the cover glass 12a. The structure layer 13a is the same as the structure layer 13 in the first embodiment or the modification examples of the first embodiment. The cover glass 12a has a front surface (first surface) 12s₁ on which light from a subject is incident, and a rear surface (second surface) 12s₂ from which light incident from the front surface is emitted. The structure layer 13a is provided at one side of the front surface 12S₁ and the rear surface 12s₂, and it is preferable to provide the structure layer on both sides of these in terms of improving an anti-reflection property and a transmitting property. In FIG. 8A, an example illustrates that the structure layer 13a is provided only at the front surface 12s₁.

As the imaging element 122, for example, a Charge Coupled Device (CCD) image sensor element, a Complementary Metal Oxide Semiconductor (COMS) image sensor element, or the like is used.

In the element package 114 according to the second embodiment, the structure layer 13a is provided on the surface of the cover glass 12a, such that it is possible to give an anti-reflection property on the surface of the cover glass 12a without causing occurrence of the interference fringes.

### MODIFICATION EXAMPLE

As shown in FIG. 8B, the transparent laminated body 11a may further include an optical low pass filter 123 and an infrared light cut filter (hereinafter, referred to as “IR cut filter”) 124 between the cover glass 12a and the structure layer 13a. In FIG. 8B, an example that the optical low pass filter 123 is provided on the surface of the cover glass 12a, and the IR cut filter 124 is provided on the surface of the optical low pass filter 123 is shown; however, an order of lamination is not limited to the example.

### 3. Third Embodiment

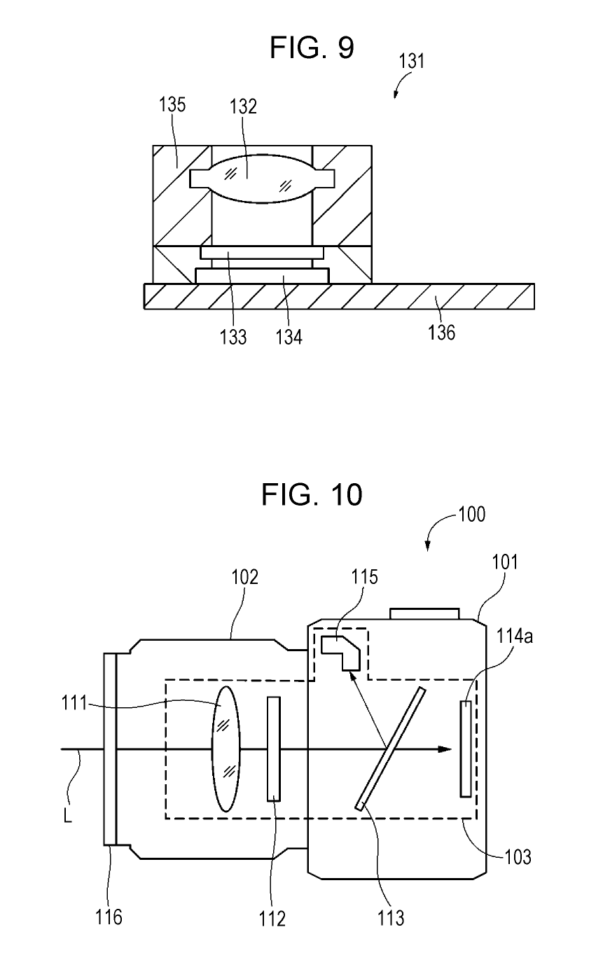

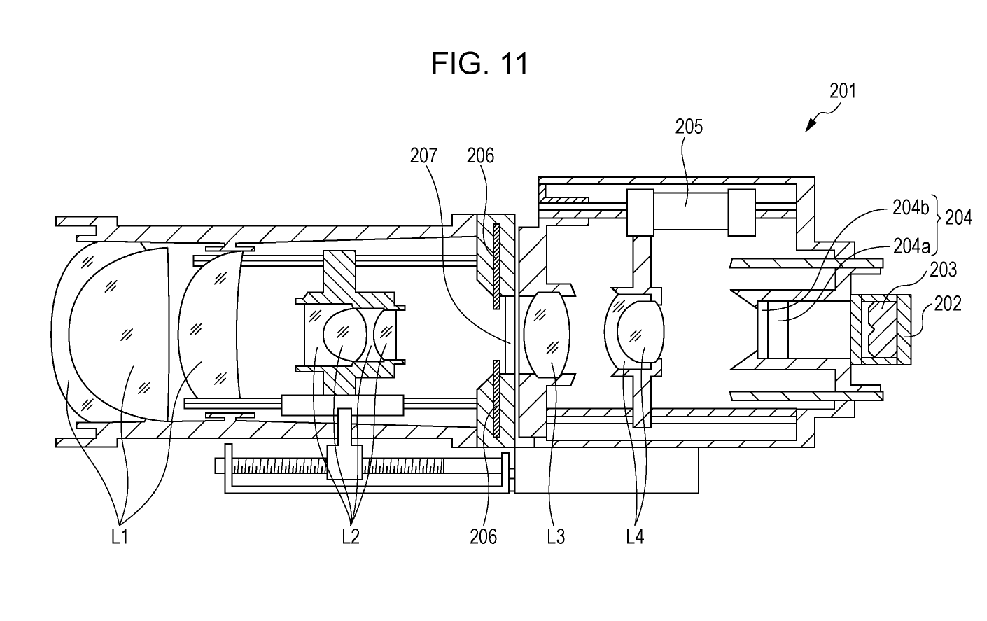

As shown in FIG. 9, a camera module (imaging module) 131 according to a third embodiment of the present technology includes a lens 132, an IR cut lens 133, an imaging element 134, a housing 135, and a circuit substrate 136. The camera module 131 is suitable for application to electronic apparatuses such as a personal computer, a tablet computer, a mobile phone, and the like.

At a predetermined position on a surface of the circuit substrate 136, the imaging element 134 is mounted. In order to accommodate the imaging element 134, a housing 135 is fixed to a surface of the circuit substrate 136. In the housing 135, the lens 132 and the IR cut lens 133 are accommodated. The lens 132 and the IR cut lens 133 are provided at predetermined intervals in this order toward the imaging element 134 from a subject. Light from the subject is collected by the lens 132, and is image-formed on an imaging surface of the imaging element 134 through the IR cut lens 133. The transparent laminated body 11 or the structure layer 13 according to the first embodiment or modification examples of the first embodiment are included on a surface of the lens 132 and the IR cut lens 133.

Here, a surface means at least one of the front surface on which light from a subject is incident and the rear surface from which the light incident from the front surface is emitted.

### 4. Fourth Embodiment

In a fourth embodiment, an example that the transparent laminated body 11 according to the above-mentioned first embodiment or the structure layer 13 of the transparent laminated body is applied to an imaging apparatus will be described.

FIG. 10 is a schematic view which illustrates an example of a configuration of an imaging apparatus according to a fourth embodiment of the present technology. As shown in FIG. 10, an imaging apparatus 100 according to the fourth embodiment is a so-called digital camera (digital still camera), and includes a housing 101, a lens barrel 102, and an imaging optical system 103 provided in the housing 101 and the lens barrel 102. The housing 101 and the lens barrel 102 may be configured to be detachable from each other.

The imaging optical system 103 includes a lens 111, a light amount adjusting device 112, a semi-transmissive mirror 113, an element package 114a, a auto-focus sensor 115. The lens 111, the light amount adjusting device 112, and the semi-transmissive mirror 113 are provided in this order toward the element package 114a from a tip of the lens barrel 102. At least one type selected from a group made of the lens 111, the light amount adjusting device 112, the semi-transmissive mirror 113, and the element package 114a is given an anti-reflection function. The auto-focus sensor 115 is provided at a position at which light L reflected by the semi-transmissive mirror 113 can be received. The imaging apparatus 100 may further include a filter 116 when necessary. When the imaging apparatus 100 includes the filter 116, the anti-reflection function may be given to the filter 116. Hereinafter, each configuration element and the anti-reflection function will be sequentially described.

### Lens

The lens 111 collects light L from a subject toward the element package 114a.

### Light Amount Adjusting Device

The light amount adjusting device 112 is a diaphragm device which adjusts a size of an opening for a diaphragm about an optical axis of the imaging optical system 103. The light amount adjusting device 112 includes, for example, a pair of diaphragm blades, and an ND filter to reduce an amount of transmitted light. As a driving method of the light amount adjusting device 112, it is possible to use, for example, a method of driving the pair of diaphragm blades and the ND filter by one actuator, and a method of driving the pair of diaphragm blades and the ND filter by respective independent two actuators; however, the driving method is not particularly limited to these methods. As the ND filter, it is possible to use a filter with a single transmittance or concentration, or a filter in which transmittance or concentration changes in a gradient shape. Moreover, the number of the ND filters is not limited to one, and a plurality of ND filters may be laminated to be used.

### Semi-Transmissive Mirror

The semi-transmissive mirror 113 is a mirror which allows a portion of incident light to transmit through, and reflects the rest. Specifically, while reflecting a portion of the light L collected by the lens 111 toward the auto-focus sensor 115, the semi-transmissive mirror 113 allows the rest of the light L to be transmitted through toward the element package 114a. As a shape of the semi-transmissive mirror 113, for example, a sheet shape and a plate shape can be exemplified; however, the shape of the semi-transmissive mirror 113 is not particularly limited to these shapes. Here, a film is defined to be included in a sheet.

### Element Package

An element package 114a receives light transmitted through the semi-transmissive mirror 113, converts the received light into an electrical signal, and outputs the signal to a signal processing circuit (not illustrated).

### Auto-Focus Sensor

The auto-focus sensor 115 receives light reflected by the semi-transmissive mirror 113, converts the received light into an electrical signal, and outputs the signal to a control circuit (not illustrated).

### Filter

The filter 116 is provided at the tip of the lens barrel 102, or in the imaging optical system 103. In FIG. 20, an example that the filter 116 is included in the tip of the lens barrel 102 is shown. When adopting this configuration, the filter 116 may be configured to be detachable from the tip of the lens barrel 102.

As the filter 116, a filter generally provided at the tip of the lens barrel 102 or in the imaging optical system 103 is used; however, the filter is not particularly limited thereto. For example, a polarization (PL) filter, a sharp cut (SC) filter, a filter for color emphasis and effects, a dimming (ND) filter, a color temperature conversion (LB) filter, a color correction (CC) filter, a white balance acquisition filter, a lens protection filter, and the like are exemplified.

### Anti-Reflection Function

In the imaging apparatus 100, light from a subject transmits through a plurality of optical elements (that is, the lens 111, the light amount adjusting device 112, the semi-transmissive mirror 113, and a cover glass of the element package 114a) until reaching an imaging element in the element package 114a from the tip of the lens barrel 102. In the following, the optical element through which the light L transmits from a subject transmits from being included in an imaging apparatus 100 until reaching an imaging element is referred to as “transmission type optical element”. When the imaging apparatus 100 further includes the filter 116, the filter 116 is also regarded as a type of the transmission type optical element.

On a surface of at least one transmission type optical element among the plurality of these transmission type optical elements, the transparent laminated body 11 according to the above-mentioned first embodiment or the structure layer 13 of the transparent laminated body is provided. Alternatively, the transparent laminated body 11 according to modification examples of the above-mentioned first embodiment or the structure layer 13 of the transparent laminated body may be provided. Here, the surface of the transmission type optical element means an incident surface on which light L from a subject is incident or an emitting surface from which incident light from the incident surface is emitted. Specifically, for example, as the element package 114a, it is possible to use the element package 114 according to the above-mentioned second embodiment or modification examples of the second embodiment.

### 5. Fifth Embodiment

In the above-mentioned fourth embodiment, a case of applying the present technology to a digital camera (digital still camera) as an imaging apparatus is described as an example; however, application examples of the present technology are not limited thereto. In a fifth embodiment of the present technology, an example that the present technology is applied to a digital video camera will be described.

FIG. 21 is a schematic view which illustrates an example of a configuration of an imaging apparatus according to a fifth embodiment of the present technology. As shown in FIG. 21, an imaging apparatus 201 according to the fifth embodiment is a so-called a digital video camera, and includes a first lens group L1, a second lens group L2, a third lens group L3, a fourth lens group L4, an element package 202, a low pass filter 203, a filter 204, a motor 205, an iris blade 206, and an electric light control element 207. In the imaging apparatus 201, an imaging optical system is configured to have the first lens group L1, the second lens group L2, the third lens group L3, the fourth lens group L4, the element package 202, the low pass filter 203, the filter 204, the iris blade 206, and the electric light control element 207. An optical adjusting device is configured from the iris blade 206 and the electric light control element 207. Hereinafter, each configuration element and the anti-reflection function will be sequentially described.

### Lens Group

The first lens group L1 and the third lens group L3 are for a fixed lens. The second lens group L2 is for a zoom lens. The fourth lens group is for a focusing lens.

### Element Package

The element package 202 converts incident light into an electrical signal, and supplies the signal to a signal processing unit which is not illustrated.

### Low Pass Filter

The low pass filter 203 is provided on, for example, a front surface of the element package 202, that is, a light incident surface of the cover glass. The low pass filter 203 is intended to suppress a false signal (moire) occurring when photographing a striped image and the like which is close to a pixel pitch, and is configured from an artificial crystal.

For example, the filter 204 is intended to cut an infrared range of light incident onto the element package 202, and to suppress a spectral floating in a near-infrared range (630 nm to 700 nm), and to make a light intensity in a visible range band (400 nm to 700 nm) uniform. The filter 204 is configured to have, for example, the infrared light cut filter (hereinafter, IR cut filter) 204a, and a IR cut coating layer 204b which is formed by laminating IR cut coating on the IR cut filter 204a. Here, for example, the IR cut coating layer 204b is formed on at least one of a surface of a subject side of the IR cut filter 204a and a surface of the element package 202 side of the IR cut filter 204a. In FIG. 21, the IR cut coating layer 204b is formed on the surface of a subject side of the IR cut filter 204a as an example.

The motor 205 moves the fourth lens group L4 based on a control signal supplied from a control unit which is not illustrated. The iris blade 206 is intended to adjust an amount of light incident onto the element package 202, and is driven by a motor which is not illustrated.

The electric light control element 207 is intended to adjust an amount of light incident onto the element package 202. The electric light control element 207 is an electric light control element which is made of a liquid crystal including at least dye-based pigment, and an electric light control element which is made of a dichroic GH liquid crystal.

### Anti-Reflection Function

In the imaging apparatus 201, light from a subject transmits through a plurality of optical elements (the first lens group L1, the second lens group L2, the electric light control element 207, the third lens group L3, the fourth lens group L4, the filter 204, and the cover glass with the low pass filter 203) until reaching an imaging element in the element package 202. Hereinafter, an optical element through which the light from a subject transmits until reaching an imaging element is referred to as “transmission type optical element”. The transparent laminated body 11 or the structure layer 13 of the transparent laminated body according to the above-mentioned first embodiment is provided on a surface of at least one transmission type optical element among the plurality of these transmission type optical elements. Alternatively, the transparent laminated body 11 or the structure layer 13 of the transparent laminated body according to modification examples of the above-mentioned first embodiment may be provided. Specifically, for example, as the element package 202, the element package 114 according to the above-mentioned second embodiment or modification example of the second embodiment can be used.

### 6. Sixth Embodiment

An electronic apparatus according to a sixth embodiment includes a camera module 131 according to the third embodiment. Hereinafter, an example of an electronic apparatus according to a seventh embodiment of the technology will be described.

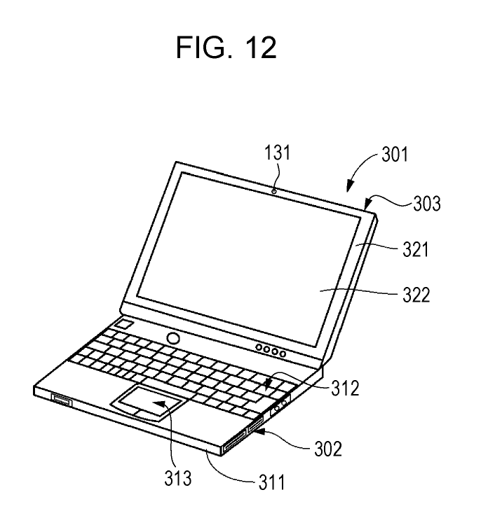

Referring to FIG. 12, an example that the electronic apparatus is a laptop computer 301 will be described. The laptop computer 301 includes a computer main body 302, and a display 303. The computer main body 302 includes a housing 311, and a keyboard 312 and a touch pad 313 accommodated in the housing 311.

The display 303 includes a housing 321, and a display element 322 and a camera module 131 which are accommodated in the housing 321. The transparent laminated body 11 or the structure layer 13 of the transparent laminated body according to the first embodiment may be included in a display surface of the display element 322. Alternatively, the transparent laminated body 11 or the structure layer 13 of the transparent laminated body according to modification examples of the above-mentioned first embodiment may be included.

When a front surface plate is provided on a front surface of the display 303, the transparent laminated body 11 or the structure layer 13 of the transparent laminated body according to the first embodiment may be provided on a surface of the front surface plate. Alternatively, the transparent laminated body 11 or the structure layer 13 of the transparent laminated body according to modification examples of the first embodiment may be included. Here, the surface means at least one of a front surface on which external light is incident and a rear surface from which external light incident from the front surface is emitted.

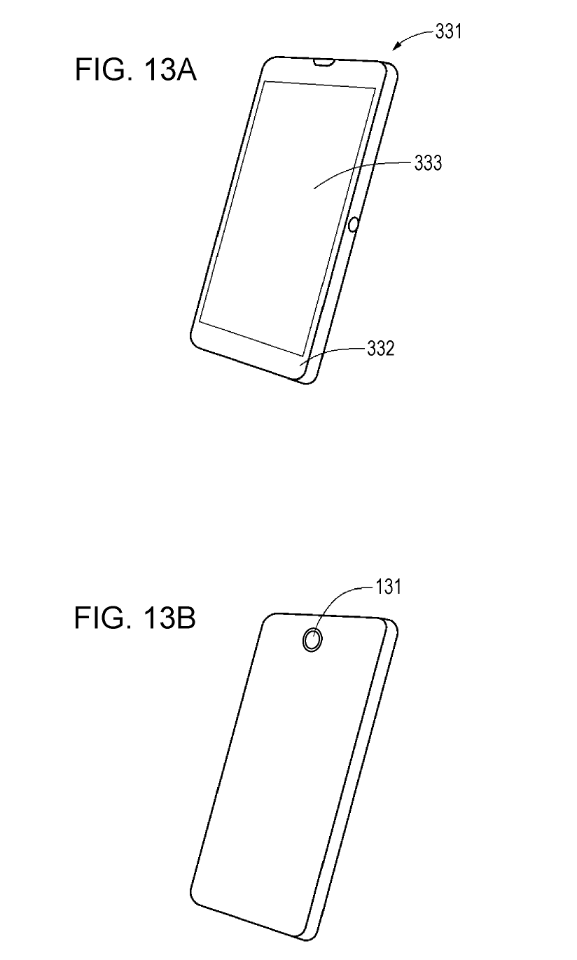

Referring to FIGS. 13A and 13B, an example that the electronic apparatus is a mobile phone 331 will be described. The mobile phone 331 is a so-called smart phone, and includes a housing 332, and a display element with a touch panel 333, and the camera module 131 which are accommodated in the housing 332. The display element with a touch panel 333 is provided on a front surface side of the mobile phone 331, and the camera module 131 is provided on a back surface side of the mobile phone 331. Here, the transparent laminated body 11 or the structure layer 13 of the transparent laminated body according to the first embodiment may be included on an input operation surface of the display element with a touch panel 333. Alternatively, the transparent laminated body 11 or the structure layer 13 of the transparent laminated body according to modification examples of the first embodiment may be included.

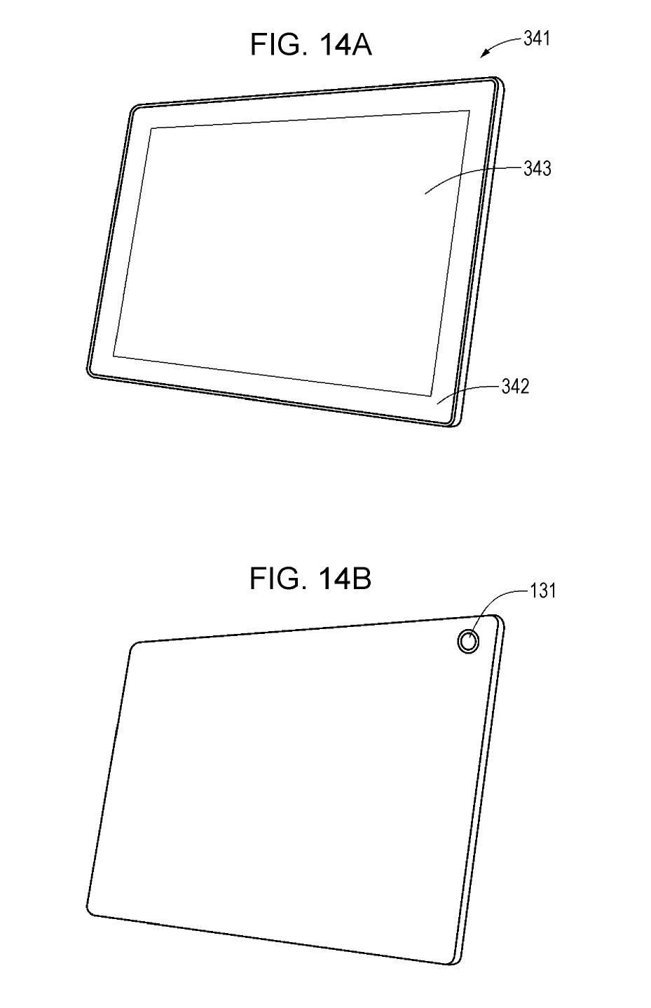

Referring to FIGS. 14A and 14B, an example that the electronic apparatus is a tablet computer will be described. The tablet computer 341 includes a housing 342, a display element with a touch panel 343 and the camera module 131 which are accommodated in the housing 342. The display element with a touch panel 343 is provided on a front surface side of the tablet computer 341, and the camera module 131 is provided on a rear surface side of the tablet computer 341. Here, the transparent laminated body 11 or the structure layer 13 of the transparent laminated body according to the first embodiment may be included on an input operation surface of the display element with a touch panel 343. Alternatively, the transparent laminated body 11 or the structure layer 13 of the transparent laminated body according to modification examples of the first embodiment may be included.

### EXAMPLE

Hereinafter, the present technology will be described in detail by examples; however, the present technology is not limited to only these examples.

Diameter D_{bottom} of a bottom, diameter Dₜₒₚ of a top, height H, and pitch P

In the present example, a diameter D_{bottom} of a bottom of a structure body, a diameter Dₜₒₚ of a top, height H, and pitch P are measured as follows. First, a transparent laminated body is cut so as to include a top of a structure body, and a cross-section of the transparent laminated body is photographed using a transmission type electronic microscope (TEM). Next, from a photographed TEM picture, a diameter D_{bottom} of a bottom of a structure body, a diameter Dₜₒₚ of a top, height H, and pitch P are determined.

A Thickness d₀ of an Intermediate Layer at a Center Point

In the present example, a thickness d₀ of an intermediate layer at a center point on a surface of the transparent laminated body is measured in a following manner. First, a transparent laminated body is cut so as to include a center point on the surface and a top of the structure body, and the cross-section is photographed using the TEM. Next, from the photographed TEM picture, a thickness d₀ of an intermediate layer at a substantially center point on the surface of the transparent laminated body is determined. Here, a distance from the surface of a glass substrate to a deepest position of a valley portion between adjacent structure bodies is defined as a thickness of the intermediate layer.

Maximum Displacement Thickness d_{Δmax} of an Intermediate Layer

In the present example, on a basis of the thickness d₀ of an intermediate layer at a center point on the surface of the transparent laminated body, a thickness d (that is, a maximum displacement thickness d_{Δmax} of an intermediate layer) of an intermediate layer at a position where an amount of change in the thickness d becomes maximum is determined. First, the transparent laminated body is cut so as to include a center point on the surface and a top of the structure body, and a cross-section of the transparent laminated body is photographed using the TEM. Next, a thickness d of an intermediate layer is determined from the photographed TEM picture. Here, a distance from the surface of a glass substrate to a deepest position of a valley portion between adjacent structure bodies is defined as a thickness of the intermediate layer. Next, the transparent laminated body is cut so as to include a center point on the surface and a top of the structure body in a direction orthogonal to the cutting direction, and a thickness d of the intermediate layer is determined in the same manner as described above. Next, from the thicknesses d of the intermediate layer in two directions determined as described above, a thickness d of an intermediate layer at a position where an amount of change in the thickness d becomes maximum is determined on a basis of a thickness d₀ at a center point, and the thickness d becomes a maximum displacement thickness d_{Δmax} of the intermediate layer.

Refractive Index n₀

In the example, a refractive index n0 of a glass substrate is measured using an Abbe refractive index meter. A measurement wavelength is 589 nm.

Refractive Index n₁

A refractive index of a UV curing resin (that is, a refractive index of an intermediate layer) n₁ is measured as follows. First, a UV curing resin used in a UV nano-imprint transfer is irradiated with 2000 mj/cm² of UV light of Hg lamp to be cured, and thereby manufacturing a sample for measurement. Next, by measuring a refractive index of the manufactured sample using the Abbe refractive index meter, the refractive index is set to be a refractive index n₁ of the UV curing resin. A measurement wavelength is 589 nm.

### Example 1

First, an 8 inch silicon wafer is spin-coated with photo resist. Next, in a stepper (reduction projection type exposure apparatus), an exposure pattern of a hexagonal lattice shape is formed. Next, after developing a photo-resist layer and forming a plurality of photo resist patterns on a silicon wafer, a plurality of anti-reflection structure bodies are formed by performing an etching process using the photo-resist pattern in a mask. Thereafter, the photo-resist pattern is removed to make a mold which has a plurality of anti-reflection structure bodies (sub-wavelength structure body) on a surface. Exposure conditions and etching conditions are adjusted so that a plurality of structure bodies having a diameter D_{bottom} of a bottom: 255 nm, a diameter Dₜₒₚ of a top: 10 nm, a height H: 300 nm, and a pitch P: 250 nm are molded in a UV nano-imprint transfer to be described below.

Next, after performing fluorine processing on a surface of the mold obtained in the above-mentioned manner, a transparent laminated body is made in a following manner by the UV nano-imprint transfer using the mold. First, after preparing a glass substrate having a refractive index n₀: 1.64, and spin-coating the glass substrate with an acrylic UV curing resin having a refractive index n₁: 1.48, and a molded surface of a mold is pressed against a coated UV curing resin. Then, after irradiating the resin with 2000 mJ/cm2 of UV light of Hg lamp to be cured, the mold is peeled off from the glass substrate. Accordingly, a transparent laminated body which has an intermediate layer (refractive index: 1.48) between the plurality of structure bodies arranged in a hexagonal lattice shape and the glass substrate is obtained. A thickness d₀ of the intermediate layer at a center point is set to be 520 nm and a maximum displacement thickness d_{Δmax} is set to be 553 nm by a pressing condition adjustment of a mold.

### Example 2

By an adjustment of the exposure conditions and the etching conditions, diameters D_{bottom} of bottoms of a plurality of structure bodies obtained by the UV nano-imprint transfer is set to be 200 nm. Moreover, by a pressing condition adjustment of a mold, a thickness d₀ of the intermediate layer at a center point is 510 nm, a maximum displacement thickness d_{Δmax} is 490 nm. Except for this, a transparent laminated body is obtained in the same manner as Example 1.

### Example 3

By an adjustment of the exposure conditions and the etching conditions, diameters Dₜₒₚ of tops of a plurality of structure bodies obtained by the UV nano-imprint transfer are 25 nm. In addition, by the pressing condition adjustment of a mold, a thickness d₀ of the intermediate layer at a center point is 505 nm, and the maximum displacement thickness d_{Δmax} is 490 nm. Except for this, a transparent laminated body is obtained in the same manner as Example 1.

### Example 4

By an adjustment of the exposure conditions and the etching conditions, diameters Dₜₒₚ of tops of a plurality of structure bodies obtained by the UV nano-imprint transfer are 30 nm. In addition, by a pressing condition adjustment of a mold, a thickness d₀ of an intermediate layer at a center point is 500 nm, and a maximum displacement thickness d_{Δmax} is 528 nm. Except for this, a transparent laminated body is obtained in the same manner as Example 1.

### Example 5

Instead of a glass substrate having refractive index n₀: 1.64, a glass substrate having refractive index n₀: 1.76 is used. In addition, by a pressing condition adjustment of a mold, a thickness d₀ of the intermediate layer at a center point is 530 nm, and a maximum displacement thickness d_{Δmax} is 506 nm. Except for this, a transparent laminated body is obtained in the same manner as Example 1.

### Example 6

Instead of the glass substrate having refractive index n₀: 1.64, a glass substrate having refractive index n₀: 1.80 is used. In addition, by a pressing condition adjustment of a mold, the thickness d₀ of the intermediate layer at a center point is 540 nm, and the maximum displacement thickness d_{Δmax} is 520 nm. Except for this, a transparent laminated body is obtained in the same manner as Example 1.

### Example 7

Instead of an acrylic UV curing resin having refractive index n₀:1.48, an acrylic UV curing resin having refractive index n₀:1.60 is used. In addition, by a pressing condition adjustment of a mold, the thickness d₀ of the intermediate layer at a center point is 550 nm, and the maximum displacement thickness d_{Δmax} is 520 nm. Except for this, a transparent laminated body is obtained in the same manner as Example 5.

### Comparative Example 1

By a pressing condition adjustment of a mold, the thickness d₀ of an intermediate layer at a center point is 490 nm, and the maximum displacement thickness d_{Δmax} is 120 nm. Except for this, a transparent laminated body is obtained in the same manner as Example 1.

### Comparative Example 2

By a pressing condition adjustment of a mold, the thickness d₀ of an intermediate layer at a center point is 510 nm, and the maximum displacement thickness d_{Δmax} is 1200 nm. Except for this, a transparent laminated body is obtained in the same manner as Example 1.

### Evaluation

The following evaluation is made for the transparent laminated body obtained as described above.

### Maximum Reflectance Ra of the Transparent Laminated Body

First, black tape is bonded on a back surface of the transparent laminated body. Next, light is incident from a surface which is a side opposite to a side to which black tape is bonded, and reflection spectrum (wavelength bandwidth 350 nm to 850 nm) of an optical film is measured by using an evaluation device (V-550) of Nippon Bunko Co. Next, from this reflection spectrum, a maximum reflectance having a wavelength bandwidth of 350 nm to 850 nm is determined.

### Maximum Reflectance Rb of a Structure Layer Itself

As described below, by manufacturing a sample of a structure layer itself, a maximum reflectance of the structure layer itself of the transparent laminated body is evaluated in a pseudo manner. First, acrylic UV curing resins having refractive indexes n: 1.48 and 1.73 used in each example and comparative example are prepared. Next, after dropping these resins on a molded surface of a mold used in each example and comparative example, pressing and curing these resins, a mold is peeled off from the cured resin. As a result, a sample of the structure layer itself is obtained. Next, in the same manner as in the evaluation of “the above-mentioned maximum reflectance of the transparent laminated body”, the reflectance spectrum is measured and maximum reflectance having a wavelength bandwidth of 350 nm to 850 nm is obtained from the reflectance spectrum.

### Relational Expression

A numerical value is obtained by substituting a thickness d₀ of the intermediate layer in each example and comparative example, and a maximum displacement thickness d_{Δmax} in the following relational expression. A value of a wavelength λ is set to be a minimum wavelength 350 nm in the wavelength bandwidth 350 nm to 850 nm. In addition, a refractive index n is set to a refractive index of the intermediate layer at a wavelength 589 nm or a refractive index n₁.

(2π/λ)·n·|d_{Δmax}−d₀|

### Interference Fringes

First, a black acrylic plate is bonded to a back surface of the transparent laminated body. Next, using 3-wavelength fluorescent lamp in a dark room, light is allowed to be incident at an incident angle of 30 degrees from a surface which is a side opposite to the side to which the black acrylic plate is bonded, and thereby regular reflection interference fringes are visually observed and are evaluated by a following reference.

O: Interference fringes are observed.
X: Interference fringes are not observed.

### Ripples

First, in the same manner as the evaluation of the above-mentioned “maximum reflectance of the transparent laminated body”, the reflectance spectrum is measured. Next, from the reflectance spectrum, ripples are measured by the following reference.

O: Maximum reflectance ≦1%
X: Maximum reflectance >1%

Tables 1 and 2 show a configuration and evaluation result of the transparent laminated body of the Examples 1 to 7, and the Comparative Examples 1 and 2.

TABLE 1

| | Dbottom | Dtop | H | P | Dtop/ | |
|---|---|---|---|---|---|---|
| | [nm] | [nm] | [nm] | [nm] | Dbottom | Dbottom/P |
| Example 1 | 255 | 10 | 300 | 250 | 0.04 | 1.02 |
| Example 2 | 200 | 10 | 300 | 250 | 0.05 | 0.80 |
| Example 3 | 255 | 25 | 300 | 250 | 0.10 | 1.02 |
| Example 4 | 255 | 30 | 300 | 250 | 0.12 | 1.02 |
| Example 5 | 255 | 10 | 300 | 250 | 0.04 | 1.02 |
| Example 6 | 255 | 10 | 300 | 250 | 0.04 | 1.02 |
| Example 7 | 255 | 10 | 300 | 250 | 0.04 | 1.02 |
| Comparative | 255 | 10 | 300 | 250 | 0.04 | 1.02 |
| Example 1 | | | | | | |
| Comparative | 255 | 10 | 300 | 250 | 0.04 | 1.02 |
| Example 2 | | | | | | |

TABLE 2

| | | | | | | | | | Evaluation | |
|---|---|---|---|---|---|---|---|---|---|---|
| | | | | | | | Maximum | Maximum | on | |
| | | | Δn | d₀ | d_{Δmax} | (2π/λ) n | reflectance | reflectance | interference | Evaluation |
| | n₁ | n₀ | (=n₁ − n₀) | [nm] | [nm] | \|D_{Δmax} − D₀\| | Ra (%) | Rb (%) | fringes | on ripples |
| Example 1 | 1.48 | 1.64 | 0.16 | 520 | 533 | 0.88 | 0.73 | 0.14 | ◯ | ◯ |
| Example 2 | 1.48 | 1.64 | 0.16 | 510 | 490 | 0.53 | 1.23 | 0.25 | ◯ | X |
| Example 3 | 1.48 | 1.64 | 0.16 | 505 | 490 | 0.40 | 0.97 | 0.21 | ◯ | ◯ |
| Example 4 | 1.48 | 1.64 | 0.16 | 500 | 528 | 0.74 | 1.45 | 0.30 | ◯ | X |
| Example 5 | 1.48 | 1.76 | 0.25 | 530 | 506 | 0.64 | 0.95 | 0.14 | ◯ | ◯ |
| Example 6 | 1.48 | 1.80 | 0.32 | 540 | 520 | 0.53 | 1.07 | 0.14 | ◯ | X |
| Example 7 | 1.60 | 1.76 | 0.16 | 550 | 520 | 0.80 | 0.97 | 0.14 | ◯ | ◯ |
| Comparative | 1.48 | 1.64 | 0.16 | 490 | 120 | 9.83 | 0.83 | 0.14 | X | ◯ |
| Example 1 | | | | | | | | | | |
| Comparative | 1.48 | 1.64 | 0.16 | 510 | 1200 | 18.33 | 0.91 | 0.14 | X | ◯ |
| Example 2 | | | | | | | | | | |

The following can be seen from the tables 1 and 2.

In the Examples 1 to 7, the intermediate layer satisfies a relation of (2π/λ)·n·|d_{Δmax}−d₀|<π, and thereby occurrence of the interference fringes is suppressed. On the other hand, in the Comparative Examples 1 and 2, the intermediate layer does not satisfy a relationship of (2π/λ)·n·|d_{Δmax}−d₀|<π, and thereby the interference fringes occur.

In the Examples 1, 3, 5, and 7, a maximum reflectance Rb of a shape single layer is 0.21% or less, a refractive index difference Δn between a refractive n₀ of the glass substrate and a refractive index n₁ of the structure layer is 0.3 or less, such that ripples are suppressed and a maximum reflectance Ra of the transparent laminated body can be 1.0% or less. On the other hand, in the Examples 2 and 4, the refractive index difference Δn is 0.3 or less. However, since the maximum reflectance Rb of the structure layer itself exceeds 0.2%, ripples are large and the maximum reflectance Ra of the transparent laminated body exceeds 1.0. Moreover, the maximum reflectance Rb of the transparent laminated body in Example 6 is 0.2% or less. However, since the refractive index difference Δn exceeds 0.3, ripples are large, and the maximum reflectance Ra of the transparent laminated body exceeds 1.0.

In the Examples 1, 3, 5, and 7, since a diameter D_{bottom} of a bottom of the structure body and a pitch P of the structure body satisfy a relationship of D_{bottom}/P>1 (that is, adjacent structure bodies overlap with each other), and a diameter Dₜₒₚ of a top of the structure body and a diameter D_{bottom} of a bottom of the structure body satisfy a relationship of Dₜₒₚ/D_{bottom}≦1/10, a maximum reflectance Rb of the structure layer itself can be 0.2% or less. On the other hand, in Example 2, since a pitch P of the structure body and a diameter D_{bottom} of a bottom of the structure body fail to satisfy a relationship of 1.2>D_{bottom}/P>1, a maximum reflectance Rb of the structure layer itself exceeds 0.2%. In addition, in Example 4, since a diameter Dₜₒₚ of a top of the structure body fails to satisfy a relationship of 1/10 or less of the diameter D_{bottom} of a bottom of the structure body, the maximum reflectance Rb of the structure layer itself exceeds 0.2%.

Accordingly, the intermediate layer satisfies a relational expression (1) below, and thereby it is possible to suppress occurrence of the interference fringes.

(2π/λ)·n(λ)·|d−d₀|<π (1)

(where, λ represents a wavelength of light for a purpose of reduction of reflection, n(λ) represents a refractive index of the intermediate layer when the wavelength is λ, d₀ represents a thickness of the intermediate layer at a center point, d represents a thickness of the intermediate layer at any point)

In addition, in order to suppress ripples, it is preferable that a maximum reflectance Rb of the shape single layer be 0.21% or less, and the refractive index difference Δn between a refractive index n₀ of the glass substrate and a refractive index n₁ of the structure layer be 0.3 or less.

In addition, in order to set a maximum reflectance Rb of the shape single layer to be 0.21% or less, it is preferable that a diameter D_{bottom} of a bottom of the structure body and a pitch P of the structure body satisfy a relationship of 1.2>D_{bottom}/P>1, and a diameter Dₜₒₚ of a top of the structure body and the diameter D_{bottom} of a bottom of the structure body satisfy a relationship of Dₜₒₚ/D_{bottom}≦10.

### Reference Example 1

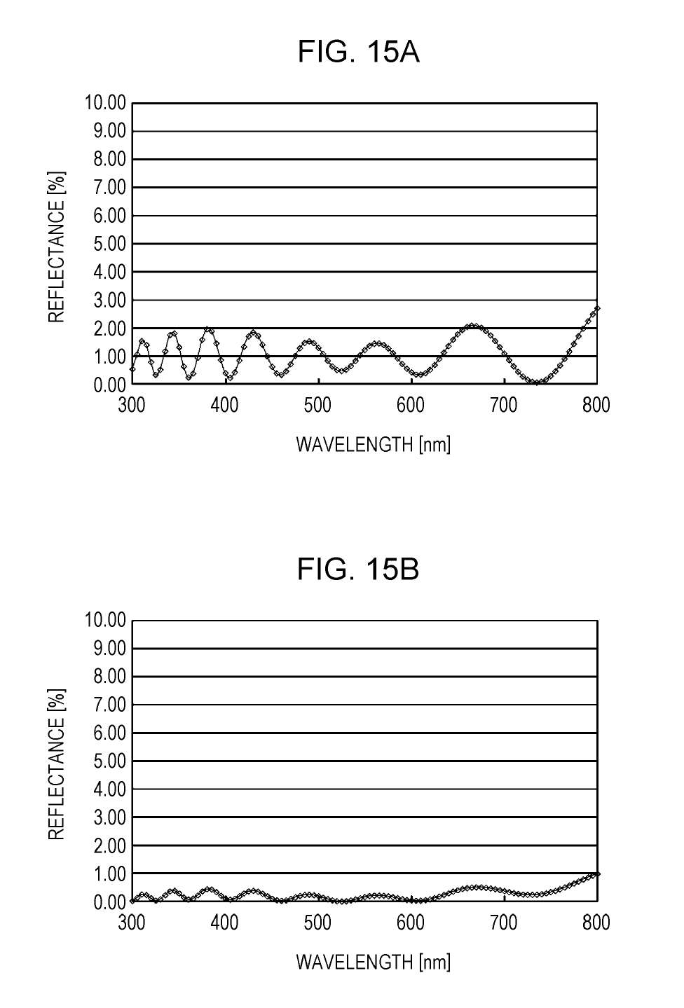

A spectrum of the transparent laminated body of the following configuration is determined by simulation. The results are shown in FIG. 15A.

Refractive index n₀ of the substrate: 1.64

Refractive index n₁ of the structure layer: 1.49

Reflectance of the structure layer itself: 0.5%

Fresnel reflectance between the structure layer and the substrate: 0.23%

### Reference Example 2

A spectrum of the transparent laminated body of the following configuration is determined by simulation. The results are shown in FIG. 15B.

Refractive index n₀ of the substrate: 1.64

Refractive index n₁ of the structure layer: 1.49

Reflectance of the structure layer itself: 0.1%

Fresnel reflectance between the structure layer and the substrate: 0.23%

The following can be seen from FIGS. 15A and 15B.

In Reference Example 1, since a reflectance of the structure layer itself exceeds 0.2%, ripples are large, and a maximum reflectance of the transparent laminated body exceeds 1.0.

On the other hand, in Reference Example 2, since a reflectance of the structure layer itself is 0.2% or less, ripples are suppressed and a maximum reflectance of the transparent laminated body is 1.0 or less.

As described above, embodiments of the present technology are described in detail. However, the present technology is not limited to the above-mentioned embodiment and various modifications based on the technical concepts of the present technology can be made.

For example, a configuration, a method, a process, a shape, a material, and a number, and the like exemplified in the above-mentioned embodiments are no more than exemplifications, and a different configuration, method, process, shape, material, number, and the like may be used when necessary.

Moreover, a configuration, a method, a process, a shape, a material, a number, and the like of the above-mentioned embodiments can be combined with each other without departing from the spirit of the present technology.

In addition, the present technology can adopt a following configuration.

(1) A laminated body includes: a substrate; and a structure layer which is provided on the substrate and has an anti-reflection function, in which the structure layer includes a plurality of structure bodies, and an intermediate layer which is provided between the plurality of structure bodies and the substrate, and in which the intermediate layer satisfies a following relational expression (1).

(2π/λ)·n(λ)·|d−d₀|<π (1)

(where, λ represents a wavelength of light for a purpose of reduction of reflection, n(λ) represents a refractive index of the intermediate layer describe above when the wavelength is λ, d₀ represents a thickness of the intermediate layer at a center point, and d represents a thickness of the intermediate layer at any point)

(2) The laminated body according to (1), in which a maximum value of reflectance of the structure layer itself with respect to light for a purpose of reduction of reflection is 0.21% or less, a maximum value of reflectance of the laminated body of the substrate and the structure layer with respect to the light for a purpose of reduction of reflection is 1.00% or less.

(3) The laminated body according to (1) or (2), in which a diameter D_{bottom} of a bottom surface of the structure body and a pitch P of the structure body satisfy a relationship of 1.2>D_{bottom}/P>1, and a diameter Dₜₒₚ of a top portion of the structure body and the diameter D_{bottom} of a bottom surface of the structure body satisfy a relationship of Dₜₒₚ/D_{bottom}≦1/10.

(4) The laminated body according to any one of (1) to (3), in which a wavelength range of the light is 350 nm to 850 nm.

(5) The laminated body according to any one of (1) to (4), in which a thickness of the intermediate layer changes in a surface direction of the substrate surface.

(6) The laminated body according to any one of (1) to (5), in which a refractive index difference Δn(=|n₁−n₀|) between a refractive index n₀ of the substrate and a refractive index n₁ of the structure layer is 0.3 or less.

(7) The laminated body according to any one of (1) to (6), in which the plurality of structure bodies and the intermediate layer are configured of the same material.

(8) The laminated body according to any one of (1) to (7), in which the structure body has a concave or convex shape with respect to a surface of the intermediate layer.

(9) An imaging apparatus including the laminated body according to any one of (1) to (8).

(10) An electronic apparatus including the laminated body according to any one of (1) to (8).

(11) A laminated body includes: a substrate; and a structure layer which is provided on the substrate and has an anti-reflection function, in which the structure layer includes a plurality of structure bodies, and an intermediate layer which is provided between the plurality of structure bodies and the substrate, and in which the intermediate layer satisfies a following relational expression (1) in any section.

(2π/λ)·n(λ)·|D−D₀|<π (2)

(where, λ represents a wavelength of light for a purpose of reduction of reflection, n(λ) represents a refractive index of the intermediate layer when the wavelength is λ, D₀ represents a thickness of the intermediate layer at a center point of the section, and D represents a thickness of the intermediate layer at any point of the section)

(12) An imaging element package includes: an imaging element; and a package which includes a light transmitting unit and accommodates the imaging element, in which the light transmitting unit includes a substrate, and a structure layer which is provided on the substrate and has an anti-reflection function, in which the structure layer includes a plurality of structure bodies, and an intermediate layer which is provided between the plurality of structure bodies and the substrate, and in which the intermediate layer satisfies a following relational expression (1).

(2π/λ)·n(λ)−|d−d₀|<π (1)

(where, λ represents a wavelength of light for a purpose of reduction of reflection, n(λ) represents a refractive index of the intermediate layer when the wavelength is λ, d₀ represents a thickness of the intermediate layer at a center point, and d represents a thickness of the intermediate layer at any point (a thickness of the intermediate layer at any point in a predetermined range centered on the center point))

It should be understood by those skilled in the art that various modifications, combinations, sub-combinations and alterations may occur depending on design requirements and other factors insofar as they are within the scope of the appended claims or the equivalents thereof.

What is claimed is:

1. A laminated body comprising:
a substrate; and
a structure layer which is provided on the substrate and has an anti-reflection function,
wherein the structure layer includes
a plurality of structure bodies, and
an intermediate layer which is provided between the plurality of structure bodies and the substrate, and
wherein the intermediate layer satisfies a following relational expression (1).
(2π/λ)·n(λ)·|d−d₀|<π (1)
(where, λ represents a wavelength of light for a purpose of reduction of reflection, n(λ) represents a refractive index of the intermediate layer when the wavelength is λ, d₀ represents a thickness of the intermediate layer at a center point, and d represents a thickness of the intermediate layer at any point)

2. The laminated body according to claim 1, wherein a maximum value of reflectance of the structure layer itself with respect to light for a purpose of reduction of reflection is 0.21% or less, and
a maximum value of reflectance of the laminated body of the substrate and the structure layer with respect to the light for a purpose of reduction of reflection is 1.00% or less.

3. The laminated body according to claim 1, wherein a diameter D_{bottom} of a bottom surface of the structure body and a pitch P of the structure body satisfy a relationship of 1.2>D_{bottom}/P>1, and
a diameter Dₜₒₚ of a top portion of the structure body and the diameter D_{bottom} of a bottom surface of the structure body satisfy a relationship of Dₜₒₚ/D_{bottom}≦1/10.

4. The laminated body according to claim 1, wherein a wavelength range of the light is 350 nm to 850 nm.

5. The laminated body according to claim 1, wherein a thickness of the intermediate layer changes in a surface direction of the substrate surface.

6. The laminated body according to claim 1, wherein a refractive index difference Δn (=|n₁−n₀|) between a refractive index n₀ of the substrate and a refractive index n₁ of the structure layer is 0.3 or less.

7. The laminated body according to claim 1, wherein the plurality of structure bodies and the intermediate layer are configured of the same material.

8. The laminated body according to claim 1, wherein the structure body has a concave or convex shape with respect to a surface of the intermediate layer.

9. An imaging apparatus comprising the laminated body according claim 1.

10. An electronic apparatus comprising the laminated body according to claim 1.

11. A laminated body comprising:
a substrate; and
a structure layer which is provided on the substrate and has an anti-reflection function,
wherein the structure layer includes
a plurality of structure bodies, and
an intermediate layer which is provided between the plurality of structure bodies and the substrate, and
wherein the intermediate layer satisfies a following relational expression (2) in any section.
(2π/λ)·n(λ)·|D−D₀|<π (2)
(where, λ represents a wavelength of light for a purpose of reduction of reflection, n(λ) represents a refractive index of the intermediate layer when the wavelength is λ, D₀: a thickness of the intermediate layer at a center point of the section, and D represents a thickness of the intermediate layer at any point of the section)

12. An imaging element package comprising:
an imaging element; and
a package which includes a light transmitting unit and accommodates the imaging element,
wherein the light transmitting unit includes
a substrate, and
a structure layer which is provided on the substrate and has an anti-reflection function,
wherein the structure layer includes
a plurality of structure bodies, and
an intermediate layer which is provided between the plurality of structure bodies and the substrate, and
wherein the intermediate layer satisfies a following relational expression (1).
(2π/λ)·n(λ)·|d−d₀|<π (1)
(where, λ represents a wavelength of light for a purpose of reduction of reflection, n(λ) represents a refractive index of the intermediate layer when the wavelength is λ, d₀ represents a thickness of the intermediate layer at a center point, and d represents a thickness of the intermediate layer at any point (a thickness of the intermediate layer at any point in a predetermined range centered on the center point))
